(19) United States
(12) Patent Application Publication
(10) Pub. No.: US 2005/0191431 A1
(43) Pub. Date: Sep. 1, 2005

(54) Method for the production of a hydrophilic substrate provided with a layer electrode

(76) Inventors: Carina Horn, Biblis (DE); Volker Unkrig, Laden burg (DE); Christine Nortmeyer, Mannheim (DE)

Correspondence Address: Roche Diagnostics Corporation, 9115 Hague Road, PO Box 50457, Indianapolis, IN, 46250-0457, US

(21) Appl. No.: 11/043,536

(22) Filed: Jan. 26, 2005

Related U.S. Application Data
(63) Continuation of application No. PCT/EP03/07331, filed on Jul. 8, 2003.

(30) Foreign Application Priority Data
Jul. 26, 2002 (DE) 102 34 114.1

(51) Int. Cl. G01N 27/26

(52) U.S. Cl. 427/419.1

(57) ABSTRACT

The present invention is generally directed towards a method for producing an analytical test strip. More particularly to a method of producing a test strip having an insulating substrate provided with a layer electrode wherein the test strip has an increased hydrophilic property.

### REFERENCE TO RELATED APPLICATIONS

The present application is a continuation of PCT Patent Application No. PCT/EP2003/007331, filed Jul. 8, 2003 which claims priority to German Patent Application No. 10234114.1, filed Jul. 26, 2002, which are hereby incorporated by reference in their entirety.

### TECHNICAL FIELD

The present invention is generally directed towards a method for producing an analytical test strip. More particularly to a method of producing a test strip having a substrate provided with a layer electrode wherein the test strip has an increased hydrophilic properties.

### BACKGROUND

Structured electrodes are typically used in microfluidic test strips for electrochemical measurements of biofluids. Typically the test strips have a capillary channel structure located on the carrier or substrate that enables the biofluid to be carried from a sample application site to a detection zone using minimal sample volumes.

Typically substrates are formed of polymer foils which do not absorb sample liquid and, due to their high hydrophobicity have a low wettability for the usually aqueous sample liquids such as blood used as an analyte for such test strips. However, such surfaces facilitate coating with an electrode material such as gold. Hence the sample liquids only flow very slowly and inhomogeneously over this material and the uptake of the analyte into the test strip system takes an unacceptably long time for the user.

In order to reduce the test time and improve the flow of sample over such surfaces, test strips having layers of foils glued on top of one another have been invented. For example, by gluing a thin masking foil with a hydrophilic surface onto parts of a conductive unstructured electrode layer. However, several complicated production steps are required for this. Due to the process complications it is possible that the analyte may not reach the actual measuring field.

It is known that efforts are underway to improve the hydrophicic properties of the test strip. One such effort is described in WO 99/29435. This publication discloses that a surface layer can be hydrophilized, i.e. its affinity for water can be increased by the action of water to increase the surface tension of objects. In particular, a metallic layer deposited on the substarte is oxidized beyond its natural oxide layer to such an extent that it loses its metallic appearance and may become completely transparent. The disclosure of WO 99/29435 with regard to this type of chemical hydrophilization is incorporated by reference into the present application.

In the above described disclosure, the increase in surface tension results from an increase in polarity and corresponds to an increased hydrophilicity of the observed surfaces. It is also observed that aqueous samples including biological samples such as blood, urine, saliva, sweat and samples derived there from such as plasma and serum spread well on such surfaces. One characteristic of such surfaces is that a boundary surface of a water drop forms an acute rim or contact angle on them. The rim angle which is a result of the surface tension of the test liquid and of the surface to be examined is a measure of the hydrophilicity of a surface.

It is against the above background that the present invention proves certain unobvious advantages and advancements over the prior art. In particular, the inventor has recognized a need for improvements in method for the production of a hydrophilic substrate provided with a layer electrode.

### SUMMARY

In one aspect of the invention provides for a method for producing a substrate provided with a layer electrode. In yet another aspect of the invention is to provide a manufacturing method for producing test strips having an optimized surface in which the conducting and hydrophilic layer of a low layer thickness adjoin one another such that the transport path for polar liquids is optimized.

In yet another aspect of the invention, the layer electrode is formed as a structured surface pattern on the substrate and the water affinity of a cover layer of the substrate is increased by a chemical or physical surface treatment.

In yet another aspect of the invention is a product comprising an insulating substrate provided with a layer electrode especially for an analytical test strip in which the layer electrode has an electrically conductive surface structure and is arranged under or on a hydrophilic cover layer.

These and other features and advantages of the present invention will be more fully understood from the following detailed description of the invention taken together with the accompanying claims. It is noted that the scope of the claims is definitely by the recitations therein and not by the specific discussion of the features and advantages set forth in the present description.

### BRIEF DESCRIPTION OF THE DRAWINGS

The following detailed description of the embodiments of the present invention can be best understood when read in conjunction with the following drawings, where like structure is indicated with like reference numerals and in which:

FIG. 1 shows a diagram of a substrate provided with a structured layer electrode; and

FIG. 2 shows the process sequence for producing an arrangement according to FIG. 1 in a block diagram.

Skilled artisans appreciate that elements in the figures are illustrated for simplicity and clarity and have not necessarily been drawn to scale. For example, the dimensions of some of the elements in the figure may be exaggerated relative to other elements to help improve understanding of the embodiments of the present invention.

### DETAILED DESCRIPTION

The following description of the preferred embodiment is merely exemplary in nature and is in no way intended to limit the invention or its application or uses.

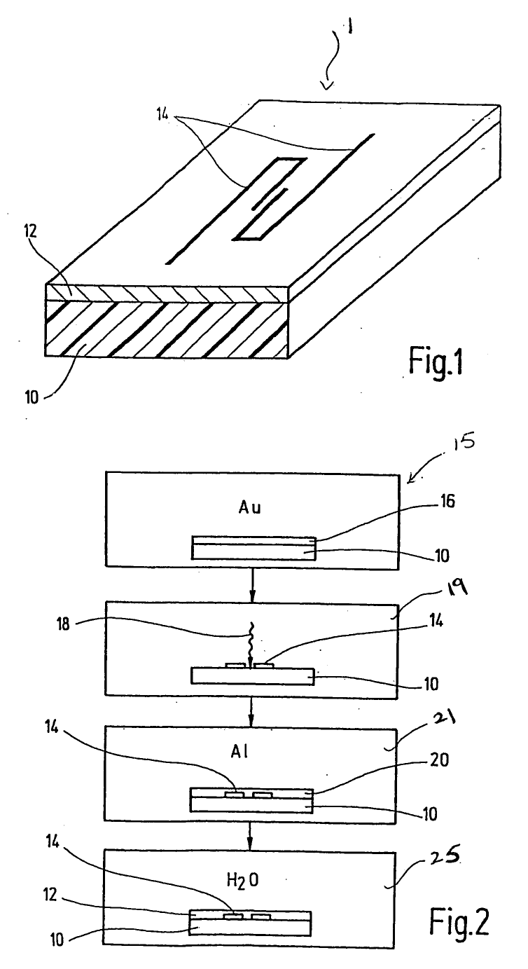

Referring in Particular to FIG. 1, an analytical test strip is generally shown and represented by reference numeral 1. The test strip 1 comprises an electrically insulating substrate 10, a hydrophilic cover layer 12 applied to the substrate 10 and a structured layer electrode 14 arranged on cover layer 12. Alternatively, the structured layer electrode 14 may be arranged under the cover layer 12. Such an arrangement can be preferably used to construct analytical test strips 1 which have a capillary channel structure (not shown) on the substrate 10 for transporting an aqueous bioliquid into the electrode area in order to carry out electrochemical analyses.

The cover layer 12 has a layer thickness of less than 100 micrometers, preferably less than 50 micrometers.

The layer electrode 14 has a layer thickness of less than 10 micrometers, preferably of less than 100 nanometers. The layer electrode 14 consists of a metallic electrode material preferably of gold, platinum, palladium or iridium. However, in principle other conducting materials such as graphite can also be used to form the layer electrode 14.

In order to manufacture such test strips 1 having the arrangement described above; it is possible to use plastic-based materials such as polymer foil to manufacture the substrates 10. The hydrophilic cover layer 12 ensures that a correct capillary path is created for the bioliquid to flow into a defined detection zone created by the structured layer electrode 14. This arrangement allows for an optimized surface in which the conducting and hydrophilic layer of a low layer thickness adjoin one another.

FIG. 2 illustrates the process sequence for manufacturing the test strip 1. As shown in FIG. 2, reference numeral 15 represents the step wherein the entire area of one side of a polyester foil 10 as a substrate is coated with a gold layer 16 by depositing or sputtering gold. Alternatively, the gold layer 16 may be deposited by evaporation coating. The thickness of the gold layer 16 is approximately 50 nm thick.

As represented by reference numeral 19, the next step in this process is to bombard the coated foil as a target with a laser beam 18 in order to ablate or evaporate certain areas of the gold layer 16, thereby forming the layer electrode structure 14. Laser ablation allows a microstructure surface pattern to be exposed and by means of a targeted transfer of energy it is possible to layer-selectively ablate the gold layer. Alternatively, the layer electrode structure 14 is already structured when it is applied to the substrate 10 using a mask or stencil in which areas are cut out. The layer electrode 14 may also be applied to the substrate 10 using the printing process.

The next step of the process is shown by reference numeral 21. This step comprises the process of vapour depositing an aluminium layer 20 on to the substrate 10 and the layer electrode 14. The thickness of the aluminium layer 20 is approximately 50 nm or 100 nm. It surprisingly turned out that when the aluminium layer 20 has a suitable thickness, the functionality of the layer electrode 14 is preserved.

As shown by reference numeral 25, the next step involves increasing the hydrophilic properties of the aluminium layer 20 by chemical treatment or modification. For this purpose the aluminium layer 20 is oxidized by boiling in a water-bath or treatment with water vapour by which means the hydrophilic aluminium oxide / hydroxide layer and cover layer 12 formed in this manner has a permanently high surface tension and polarity in order to achieve good flow properties of a polar liquid sample. In this connection it has turned out that as a result of the low layer thickness and porosity of the oxide layer 12, the functionality of the electrode structure 14 is essentially not impaired. Plasma treatment may also be used as an alternative method of improving the hydrophilic properties of the aluminium layer 20. Alternatively, a suitable chemical surface modification can also be achieved by hydrophilizing the aluminium layer 20 by hydrolysis of a phosphoric acid ester.

The order of the processes described above can in principle be varied depending on the materials that are used. In one of the alternate embodiment, not shown in the drawings, the substrate 10 is coated with a starting material for the cover layer 12. Preferably, the substrate 10 is deposited with aluminium as a starting material for the cover layer 12. Preferably, aluminium is deposited on the substrate 10, using the vapour-deposition method. This alternative process enables a hydrophobic substrate material to be provided with a hydrophilic surface in a simple manner without impairing the production of a defined electrode structure. The layer electrode 14 is then generated on the aluminium layer 20 using the methods described above. In this case it is possible to convert the aluminium layer into a hydrophilic cover layer 12 before or after applying the electrode structure 14.

It is noted that terms like “preferably”, “commonly”, and “typically” are not utilized herein to limit the scope of the claimed invention or to imply that certain features are critical, essential, or even important to the structure or function of the claimed invention. Rather, these terms are merely intended to highlight alternative or additional features that may or may not be utilized in a particular embodiment of the present invention.

For the purposes of describing and defining the present invention it is noted that the term “substantially” is utilized herein to represent the inherent degree of uncertainty that may be attributed to any quantitative comparison, value, measurement, or other representation. The term “substantially” is also utilized herein to represent the degree by which a quantitative representation may very from a stated reference without resulting in a change in the basic function of the subject matter at issue.

Having described the invention in detail and by reference to specific embodiments thereof, it will be apparent that modification and variations are possible without departing from the scope of the invention defined in the appended claims. More specifically, although some aspects of the present invention are identified herein as preferred or particularly advantageous, it is contemplated that the present invention is not necessarily limed to these preferred aspects of the invention.

1. A process for producing an analytical test strip having an insulating substrate, wherein the substrate has a layer electrode, the process comprising:
depositing a metallic layer on the substrate;
forming the layer electrode as a structured surface pattern on the substrate;
depositing a cover layer on the substrate and the layer electrode; and
treating the cover layer with a chemical or physical surface treatment such that the water affinity of the cover layer is increased.

2. The process as claimed in claim 1 comprising coating the substrate with aluminium as a starting material of the cover layer.

3. The process as claimed in claim 1, wherein after applying the layer electrode, the substrate is preferably provided with the cover layer over its entire surface.

4. The process as claimed in claim 1, wherein the layer electrode is geometrically structured by selectively ablating certain areas of a previously formed electrode layer.

5. The process as claimed in claim 1, wherein the layer electrode is structured when it is applied using a mask.

6. The process as claimed in claim 1, wherein the layer electrode is applied in a structured manner by a printing process.

7. The process as claimed in claim 1, wherein the layer electrode has a layer thickness of less than 10 micrometers, preferably of less than 100 nanometers.

8. The process as claimed in claim 1, wherein the layer electrode is composed of a metallic electrode material preferably of gold, platinium, palladium or iridium.

9. The process as claimed in claim 1, wherein the substrate is composed of a hydrophobic insulating material.

10. The process as claimed in claim 1, wherein the surface treatment of the cover layer is done by the action of water.

11. The process as claimed in claim 1, wherein the cover layer is composed of an inorganic starting material that can be oxidized by water and is hydrophilized by treatment with hot water or water vapour.

12. The process as claimed in claim 1, wherein the cover layer is hydrophilized by hydrolysing a phosphoric acid ester.

13. The process as claimed in claim 1, wherein the cover layer is formed with a layer thickness of less than 100 micrometers, preferably of less than 50 micrometers.

14. A process for producing an analytical test strip having an insulating layer substrate, wherein the substrate has a layer electrode, the process comprising:
depositing a cover layer on the substrate;
treating the cover layer with a chemical or physical surface treatment such that water affinity of the cover layer is increased; and
forming the layer electrode as a structured surface pattern on the substrate.

15. The process as claimed in claim 14, wherein the step of treating the cover layer is prior to the step of forming the layer electrode.

16. The process as claimed in claim 14, wherein the step of treating the cover layer is after the step of forming the layer electrode.
